(19) United States
(12) Patent Application Publication
(10) Pub. No.: US 2005/0180581 A1
(43) Pub. Date: Aug. 18, 2005

(54) Integrated microphone array

(76) Inventor: Meir Botbol, Pardes Hana (IL)

Correspondence Address: NATH & ASSOCIATES, 1030 15th STREET, NW, 6TH FLOOR, WASHINGTON, DC, 20005, US

(21) Appl. No.: 10/771,140

(22) Filed: Feb. 4, 2004

(51) Int. Cl. H04R 3/00

(52) U.S. Cl. 381/92; 381/176; 381/178

(57) ABSTRACT

A microphone for detecting vibrations at two or more locations on a surface such as a body surface. The microphone comprises two or more vibration sensors, where each vibration sensor has a diaphragm. The diaphragms are arranged in an overlapping array so that vibrations at at least one location on the surface are detectable simultaneously by at least two of the vibration sensors. The invention also provides a system for recording sounds from a surface comprising one or more microphones of the invention and a processor configured to determine a vibration at one or more locations of overlap between the diaphragms.

### FIELD OF THE INVENTION

This invention relates to microphones.

### BACKGROUND OF THE INVENTION

It is well known to apply a microphone to a body surface in order to detect body sounds. When it is desired to detect body sounds simultaneously at several locations over the body surface, a separate microphone may be applied to the surface at each location where sounds are to be detected. Systems for detecting and analyzing lung sounds in which a plurality of microphones are attached to an individual's chest or back over the lungs is disclosed in Kompis et al. (Chest 120(4):2001) and in Applicant' WO 03/057037.

### SUMMARY OF THE INVENTION

The present invention provides an integrated microphone array for simultaneously detecting sounds at a plurality of locations over a surface, such as a body surface. The array includes a plurality of diaphragms. The diaphragms are generally rectangular in shape and are formed from a Piezoelectric material such as PVDF (polyvinylidene fluoride), having a conductive layer on one or both diaphragm surfaces. The diaphragm generates a voltage when a strain is applied. A vibration in a diaphragm thus generates a voltage signal indicative of the vibration.

In the microphone array of the present invention, two or more diaphragms are arranged in array in which each diaphragm overlaps at least one other diaphragm in the array. When the array is placed on the surface, each diaphragm collects vibrations only from the region of the surface in contact with the diaphragm.

In one embodiment of the invention, on one side of the array at one or more overlaps of the diaphragms, a spacer is attached. The array is placed on the surface from which sounds are to be deleted, with only the spacers in contact with the surface and the diaphragms themselves spaced away from the surface at a distance about equal to the thickness of the spacers. When the array is placed on the surface in this way, the array collects vibrations only from locations on the surface in contact with a spacer.

A voltage signal is generated by each diaphragm that is indicative of the integral of all the vibrations in the locations on the surface in contact with the diaphragm. A system of equations is generated that may be solved to calculate the vibration at each location on the surface in contact with the array. The inventors have found that the sound vibrations determined at a plurality of locations on the surface using the integrated microphone array of the invention is less prone to noise than detecting vibrations at these locations by placing an independent microphone at each location.

Thus, in its first embodiment, the invention provides a microphone for detecting vibrations at two or more locations on a surface comprising two or more vibration sensors, each vibration sensor having a diaphragm, the diaphragms being arranged in an overlapping array so that vibrations at at least one location on the surface are detectable simultaneously by at least two of the vibration sensors.

In its second embodiment, the invention provides a system for recording sounds from a surface comprising:

(a) one or more microphones according to claim 1;

(b) a processor configured:
(i) to receive, for each vibration sensor in the microphone or microphones, a signal indicative of the integral of vibrations detected by the vibration sensor, and
   (ii) to determine in a calculation based upon the received signals, a vibration at one or more locations of overlap between the diaphragms.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 shows an integrated microphone array in accordance with one embodiment of the invention;

FIG. 2 shows an electric circuit comprising a diaphragm; and

FIG. 3 shows a system for recording body sounds comprising the integrated microphone array of the invention.

### DETAILED DESCRIPTION OF THE INVENTION

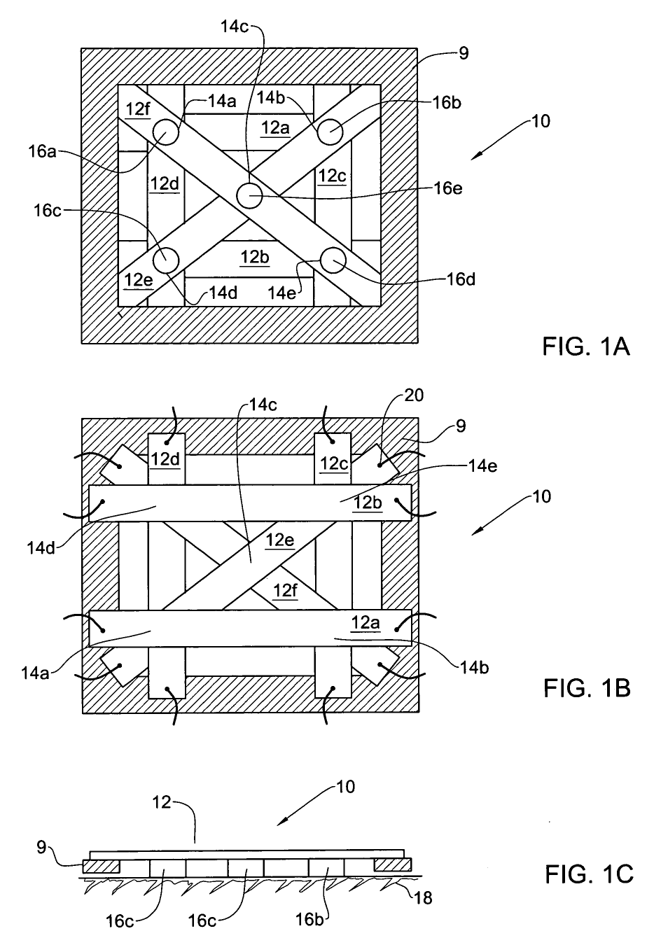

FIG. 1 shows an integrated microphone array 10 in accordance with one embodiment of the invention. The array 10 is shown in FIG. 1a in a bottom view, in FIG. 1b in a top view, and in FIG. 1c in a side view.

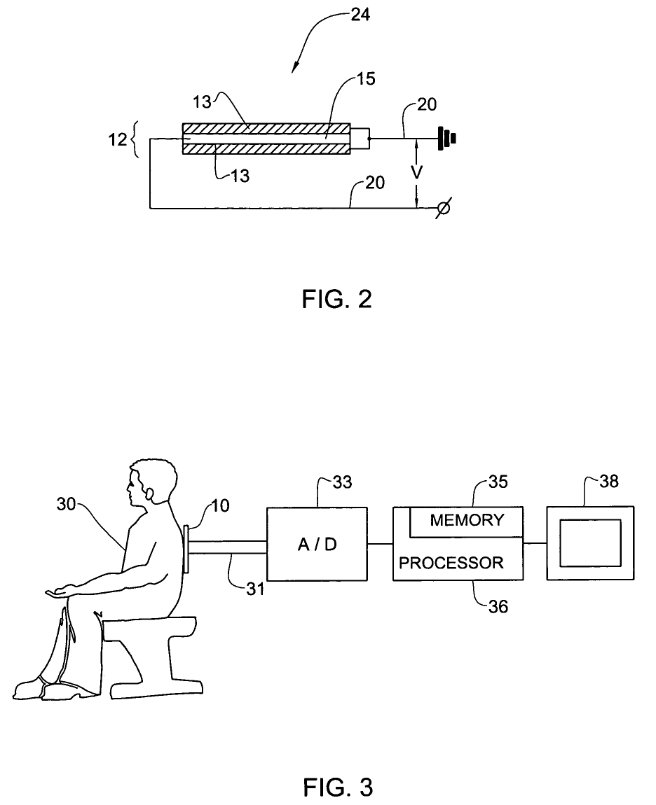

The array 10 comprises six diaphragms 12a to 12f. This is by way of example only, and the array of the invention may comprise any number of diaphragms greater than or equal to two. The diaphragms are thin plates made from a piezoelectric material such as PVDF, having a conductive layer on one or both diaphragm surfaces. As shown in FIG. 2, each diaphragm 12 is part of an electric circuit 24. The metal coating 13 on each diaphragm 12 is grounded, and a voltage signal relative to the ground is obtained from the PVDF layer 15 in the diaphragm.

Referring again to FIG. 1, the diaphragms are arranged in an overlapping array, so that the array has several regions where two or more diaphragms 12 overlap. In the array of FIG. 1, five overlapping regions 14a to 14e are present. This is by way of example only, and the invention may be implemented with any number of overlapping regions. At each overlapping region a spacer 16 is placed. The spacers are disks having a diameter small enough to as to be contained within the confines of the overlapping regions 14.

The ends of the diaphragms in the overlapping array are attached to a frame 9 that surrounds the array 10. In use, the frame array 10 is firmly fixed on a surface 18 from which vibrations are to be colleted, as shown in FIG. 1c. The surface 18 may be, for example, a body surface, such as an individual's chest or back. The array 10 is placed with the spacers 16 in contact with the surface 18 and the diaphragms 12 spaced away from the surface 18 by a distance approximately equal to the thickness of the spacers 16. The frame may be affixed to the surface by means of a vacuum or straps or by being embedded in or on a special garment.

Vibrations in the surface 18 are conducted through the spacers 16 to the array of diaphragms. Each specific spacer 16 will conduct vibrations only to the diaphragms 12 in the overlapping region 14 overlying that spacer 16. For example, vibrations in the region of the surface 18 in contact with the spacer 14c will be conducted through the spacer 14c to the diaphragms 12e and 12f. These vibrations essentially will not be conducted to the other diaphragms (diaphragms 12a, 12b, 12c and 12d).

Thus, vibrations arising in a specific diaphragm 12 will be the result only of the vibrations in the spacers at the overlapping regions 14 involving that specific diaphragm. For example, the vibrations arising in the diaphragm 12e will be due to the vibrations in the spacers 16b, 16c and 16d. The other spacers (16a, 16e and 16f) do not contribute to the vibrations in the diaphragm 12e.

FIG. 3 shows a system for detecting body sounds comprising the integrated microphone array 10 of the invention. The one or more microphone arrays of the invention such as the array 10 has been fixed onto a body surface of an individual 30 for recording body sounds simultaneously at a plurality of locations on the body surface. A cable 31 contains the wires 20 (FIGS. 1 and 2). M analog voltage signals V (FIG. 2) are generated by the array 10, where M is the total number of diaphragms in the array or arrays. The M analog signals Vᵢ(t), I from 1 to M are digitized by means of an analog to digital converter 33. The digitized signals are stored in the memory 35 of a processing unit 36. The processing unit 36 is configured to determine the sound vibrations at one or more of the spacers 14 from one or more of the vibrational signals generated by the diaphragms 12 in the array or arrays. The results of the analysis may be displayed on a display device such as a computer screen 38.

The processing unit 36 is configured to analyze the M voltage signals V₁, . . . Vₘ and determine a vibration Xⱼ(t), . . . j=1, . . . N at each of the N overlapping regions of the array.

In one embodiment, the N vibrations are estimated by assuming a linear model:
V=(V₁(t), . . . vₘ(t)
V=AX
and X=(x₁(t), . . . X_{N}(t)).

Where A is an MXN matrix which establishes the correspondence between the vector V and the vector X. The matrix A may be obtained empirically. If M>N then the system of equations V=AX is over determined, and may be solved for example, using a least-squares analysis.

In another embodiment, a non-linear relationship between Y and X is used. In this case a system of non-linear equations is obtained that may be solved by any known method for solving systems of non-linear equations.

1. A microphone array for detecting vibrations at two or more locations on a surface comprising
two or more vibration sensors, each vibration sensor having a diaphragm, the diaphragms being arranged in an overlapping array so that vibrations at at least one location on the surface are detectable simultaneously by at least two of the vibration sensors.

2. The microphone according to claim 1 wherein a vibration sensor is a diaphragm formed from a piezoelectric material having a conductive film on at least one diaphragm surface.

3. The microphone according to claim 1 further comprising a spacer attached to one or more regions of overlap between diaphragms in the array.

4. The microphone according to claim 1 further comprising a frame attached to each vibration sensor.

5. The microphone according to claim 2 wherein the conducting surface or surfaces are grounded and a voltage signal is obtained from the piezoelectric material indicative of the integral of the vibrations detected by the vibration sensor.

6. The microphone according to claim 1 wherein the surface is a body surface.

7. A system for recording sounds from a surface comprising:
(a) one or more microphones according to claim 1;
(b) a processor configured:
(i) to receive, for each vibration sensor in the microphone or microphones, a signal indicative of the integral of vibrations detected by the vibration sensor, and
(ii) to determine in a calculation based upon the received signals, a vibration at one or more locations of overlap between the diaphragms.

8. The system according to claim 7 further comprising a display configured to display results of an analysis of one or more of the electrical signals.

9. The system according to claim 7, wherein determining a vibration at one or more locations involves solving a linear system of equations.

10. The system according to claim 7, wherein determining a vibration at one or more locations involves solving a non-linear system of equations.

11. The system according to claim 7 wherein the surface is a body surface.
